(19) United States
(12) Patent Application Publication
(10) Pub. No.: US 2006/0136558 A1
(43) Pub. Date: Jun. 22, 2006

(54) Event manager for use in a facilities monitoring system having network-level and protocol-neutral communication with a physical device

(75) Inventors: Thomas Sheehan, Soperton, GA (US); Jay Hartley, San Ramon, CA (US); Ziji Zhang, Dublin, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Modius, Inc., Pleasanton, CA (US)

(21) Appl. No.: 11/313,260

(22) Filed: Dec. 19, 2005

Related U.S. Application Data
(60) Provisional application No. 60/637,612, filed on Dec. 17, 2004.

(51) Int. Cl. G06F 15/16

(52) U.S. Cl. 709/203

(57) ABSTRACT

A method and a system for the off site monitoring/diagnostics, command/control, alarm/event management, historical/trend analysis, and configuration/administration of building automation systems through an event manager for use in a facilities monitoring system having network-level and protocol-neutral communication with a physical device. The method includes managing a non internet protocol-based physical device, including coupling a device gateway with the physical device, wherein the device gateway is configured to expose the physical device as a networked device on a server. The method also includes receiving event information from the coupled physical device, wherein the event information includes an event and a device identifier; responsive to a determination that the event information includes an actionable event, processing the event, the device identifier, and the actionable event to determine a responsible process; and notifying the responsible process of the event.

### CROSS-REFERENCES TO RELATED APPLICATIONS

This application claims priority to U.S. Provisional Patent Application No. 60/637,612, filed Dec. 17, 2004, the disclosure of which is hereby incorporated by reference herein in its entirety for all purposes.

### BACKGROUND OF THE INVENTION

The present invention relates in general to an event manager for use in a facilities monitoring system having network-level and protocol-neutral communication with a physical device.

Networked intelligent devices are virtually everywhere today, embedded into building management systems, medical devices, home thermostats, commercial chillers, HVAC systems, and automobiles to name a few. Embedded software developers have long been aware of the engineering challenges and high costs associated with adding management capabilities to devices. A significant problem is that the technologies available in the marketplace today often are limited to a specific manufacturers' products or a specific industry, and are only appropriate for certain customer requirements. As a result, the absence of a truly flexible, standards-based and cost-effective remote management solution has encumbered device manufacturers and their consumers from realizing the benefits of the connectivity they desire.

For example, the controls industry has traditionally performed the monitoring and control functions that manage automated devices within large enterprises. Their technology, however, is very limited and very costly to install and maintain. Using proprietary protocols and cumbersome architecture, they are unable to effectively access valuable data from the disparate and ever-growing variety of devices available today. As more devices come to market, enterprises demand new solutions to mine the intelligence of these resources and to integrate them into their increasingly complex networks. The problem facing enterprises, service providers and manufacturers alike is how to get disparate intelligent devices to speak the same language and communicate what they know throughout the enterprise.

While connection with these disparate devices may be available, there exists a need for a reliable way of managing events that occur at these devices.

### BRIEF SUMMARY OF THE INVENTION

The present invention provides a method of managing a non internet protocol-based physical device. The method includes: coupling a device gateway with a non internet protocol-based physical device, the device gateway configured to expose the physical device as a networked device on a server; receiving event information from the physical device, wherein the event information includes an event and a device identifier; responsive to a determination that the event information includes an actionable event, processing the event information, the device identifier, and the actionable event to determine a responsible process; and notifying the responsible process of the event.

In one aspect, the event information is related to a discovery event, wherein a discovery event occurs when a physical device is coupled with the device gateway.

In another aspect, the event information is related to a discovery event, wherein a discovery event occurs when a physical device is decoupled from the device gateway.

In another aspect, the event information is related to a discovery event, wherein a discovery event occurs when meta-information about the device gateway is changed. A change in a meta-information can be a change in the name, change in the make, change in the model, change in the point information, change in the alarm information, and combinations thereof, for a component of the device gateway.

In another aspect, the event information includes data event information. Data event information includes information related to a raw data event, a state change event, an alarm event, and combinations thereof.

In one aspect, the processing of the event information includes updating an event database.

In another aspect, the processing of the event includes inserting audit records into an event database.

In another aspect, the notifying includes exchanging the event data with a mail server.

For a fuller understanding of the nature and advantages of the embodiments of the present invention, reference should be made to the following detailed description taken in conjunction with the accompanying drawings.

### BRIEF DESCRIPTION OF THE DRAWINGS

FIG. 1 is an exemplary block diagram of the software components of the event manager in accordance with one embodiment of the present invention.

FIG. 2A is an exemplary block diagram of the subcomponents of the event manager in accordance with one embodiment of the present invention.

FIG. 2B is an exemplary block diagram of the event manager in accordance with one embodiment of the present invention exchanging data with object adapters.

FIG. 3 is an exemplary block diagram of the meta-data event processor chain for the event manager, in accordance with one embodiment of the present invention.

FIG. 4 is an exemplary block diagram of the data processor event dispatching for the event manager, in accordance with one embodiment of the present invention.

### DETAILED DESCRIPTION OF THE INVENTION

Definition of Terms

The following terms are defined as follows:

Alarm—Any event that is determined to be high priority and/or actionable. Alarms include remote controller failures, Communications Check failures, and Collection Point failures.

API—Application Program Interface.

BAS—Building Automation System.

Event—An event is a change in status at the customer site (e.g., BAS site), which may or may not be an alarm indicating an other-than-normal condition at the customer site. Events may also be received from via phone, fax, or email providing feedback on the status of the site.

Data Collector System—A system that collects data, and which automates the capture and normalization of events.

Event Management System—A service that receives and processes event data. The event management system has the capacity to deal with any special events it detects, or to pass event information for management by an enterprise application. As used herein, an event can be any occurrence that requires intervention by man or machine, and intervention by machine can include storing a value in a database, for example, for non-alarm events. An event can be any occurrence that is catalogued in the system. Also, as used herein, when information from a subject device varies from pre-determined limits, that variance can constitute an alarm event. An alarm event can also be defined as a variance from a target defined by either manufacturer specification or by the user of the system. For example, the manufacturer specification of an MGE UPS device says, “This 12KVA box has two hours of available battery time.” The user, however, specifies, “I don't want to push this to the limit; I want to be notified when there is only one hour of battery time remaining.” Both of these requirements represent a target in the system, against which to compare data extracted from the subject device. Targets can be generated in the system using calculated “data points.” A data point is any signal emitted from a subject device that is used in comparison to target values for the data. Each point represents a source of signal data that, in general, will vary over time as environmental conditions change.

The event manager which is a part of the event management system of the present invention can interface with a data collection and/or a data point calculating system. The event manager by using a pre-defined rule set, can check the state of all the connected devices, and can spot when devices are no longer in harmony with their optimal condition. When the event manager determines that an event condition exists, it either passes the information to an outside application or to an event manager component.

The event manager can work in conjunction with other software modules provided by the assignee herein, for monitoring, energy management, maintenance, analysis or reporting. The event manager also works independently with other competitive systems, such as network management systems (NMS), building automation systems (BAS), and other monitoring systems.

Event Processing Subsystem—A subsystem of the Event Management System, which automates the processing of captured events.

FMS—Facility Management System.

HTTP—Hypertext Transport Protocol.

HTTPS—Secure Hypertext Transport Protocol.

Service Technician—A technician that travels to a customer site to correct a problem/make a repair. A service technician is interested in seeing events.

The present invention provides a method and a system for the off site monitoring/diagnostics, command/control, alarm/event management, historical/trend analysis, and configuration/administration of building automation systems through an event manager system.

In one embodiment, the event manager is a client service operating as part of the larger communication network. The event manager can interact with one or more remote or local Protocol Object Adapters (POAs) which can be a part of a device gateway architecture. A POA can be coupled with a physical device to enable a non internet-protocol physical device to be exposed as a networked device on a server. Further details of the device gateway architecture are described in a co-pending patent application, entitled: “UNIVERSAL CONFIGURABLE DEVICE GATEWAY,” U.S. patent application Ser. No. 11/194,114; Attorney Docket: 022357-000110US, the teachings of which are herein incorporated by reference in their entirety. The event manager can manage events occurring at the POA level.

As used herein, the physical device with which communication and/or control is desired, may be a power distribution equipment, environmental control equipment, security monitoring equipment, health/safety and fire equipment, a power supply device, an uninterrupted power supply (UPS), a compressor, any other infrastructure device or system, a serial gateway, a head-end system, a programmable logic controller (PLC), an HMI workstation, an IT server or a management system, or any device that supports industry-accepted protocols, including ModBus, Lon, DF1, N2, BACnet, CIP and SNMP, as well as other industry-accepted protocols, but other devices might also be so controlled. Each such device is capable of generating and receiving I/O information over its vendor-defined communication interface, which might be an RS-232, RS-422, RS-485, Ethernet or contact closure harnessing interface, for example. I/O information is communicated between the device and a client application or device in accordance with the device vendor's defined native language protocol.

The two primary categories of events are discovery and data events. Discovery events can occur when new POAs are added, existing POAs are deleted, or the meta-information about a POA is changed. A change in a meta-information includes changes in the name, make, model, point information, alarm information, etc. for a given POA. Data events result from the POA data collection or “polling” process, and include raw data events, state change events, and alarm events.

In processing both kinds of events, the event manager updates an event database. Discovery events can result in changes to the device and point descriptive information. Data events are stored as time series values.

Data events can also trigger system responses such as email and pager notifications. The event manager not only can provide the notifications to a database configuration, but also can insert audit records of its actions.

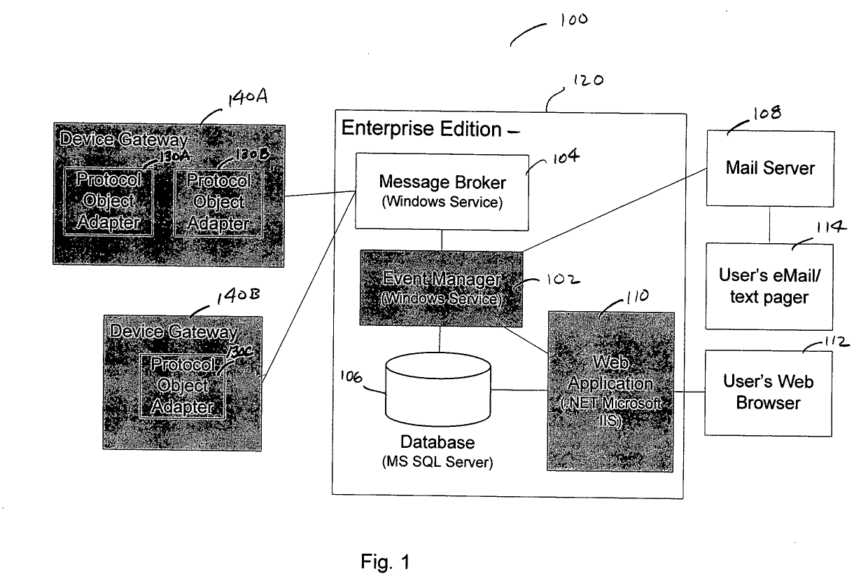

FIG. 1 shows an exemplary block diagram 100 of the software components of the event manager in accordance with one embodiment of the present invention. As seen in FIG. 1, the event manager 102 uses a message bus via a message broker 104 to interact with remote POAs 130A, B, C, . . . . As used herein, for one implementation, the message bus is referred to as the Open Data Message Service (ODMS), however other message bus implementations such as Sun's JMS, the Spread message bus, or the Tibco message bus may also be used. The event manager 102 stores device data and meta-data in a database 106, and also sends event notifications to users via an email server 108. An email server 108 can forward the user's email to a mail client or a pager 114. The data and meta-data inserted by the event manager can be displayed by a web application 110. The event manager's notification process is configured by database entries made through the web application 110. For some purposes, the event manager may interact directly with the Web user interface 112, by posting data to particular URLs. However, most communications between the two modules (i.e., event manager and Web application) can be carried out indirectly through the database.

In one specific embodiment, the event manager can be implemented using the Java programming language. However, it should be appreciated that computer code for implementing aspects of the present invention can be C, C++, HTML, XML, JavaScript, etc. code, or any other suitable scripting language (e.g., VBScript), or any other suitable programming language that can be executed on a suitable computing platform. While the event manager 102 is shown to be running on the same platform as both the message broker 104 and the database 106, it should be appreciated that the various components can be running on different hardware platforms.

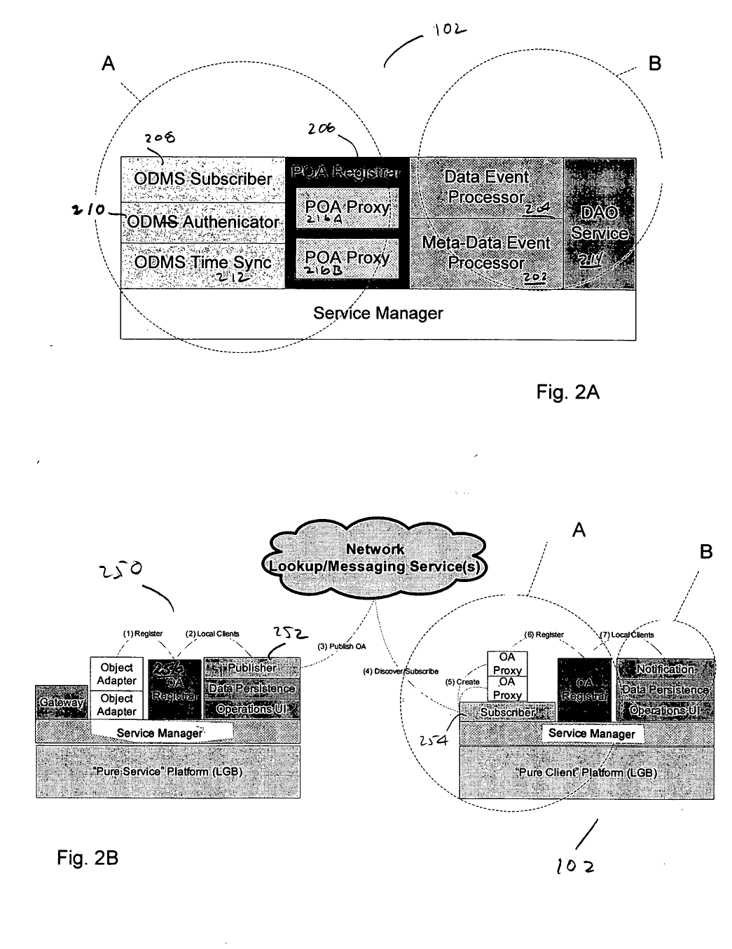

FIG. 2A shows an exemplary block diagram of the subcomponents of the event manager 102 in accordance with one embodiment of the present invention. In one implementation, the event manager 102 includes an instance of the POA client 206, combined with two parallel event processing services (204 and 202). One service, the meta-data event processor 202, processes POA discovery and configuration changes, for example, meta-data events. The other, data event processor 204 processes data events. In addition to the message bus subscriber 208, the event manager also provides centralized authentication via the message bus authenticator 210, and time synchronization via message bus time sync 212. The bus time sync 212 prevents the distributed systems from being grossly out of sync. The DAO (data access layer) service can provide a consistent interface between the application layer and the persistent storage, or database. It is an optional component when a persistent data store exists. The service manager launches the processes that include the event manager. The message bus subscriber 208 is the client process that registers interest in being notified for messages regarding particular objects of interest.

The message bus authenticator 210 serves to authenticate a message. The message bus authenticator 210 can pass a username and password to the event manager system 120 user interface through a post to a URL. This will ensure that users created in the event manager system 120 can access individual Device Gateways 140A, B with the same username and password. It should be noted that the DAO, the service manager, the subscriber, and authenticator processes are not part of the Event Manager per se. These components are used by the event manager, so they are related to its architecture.

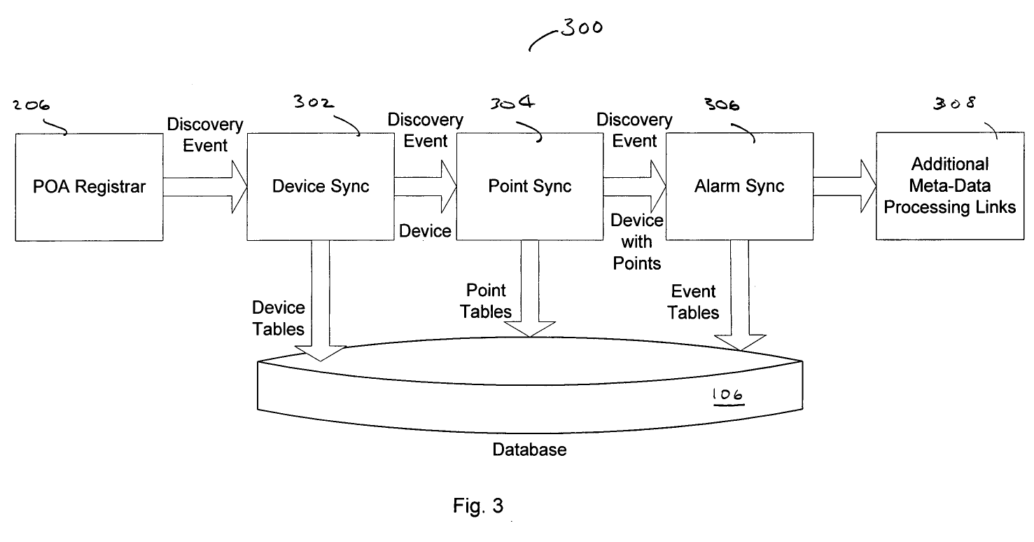

FIG. 3 shows an exemplary block diagram 300 of the meta-data event processor chain for the event manager, in accordance with one embodiment of the present invention. The meta-data event processor 202 is responsible for keeping the event manager database 106 entries describing a device and its points synchronized with the meta-data provided by the POAs through their proxies (216A, B, . . . ). The meta-data event processor is structured as an event processing chain, following a variety of the chain of responsibility pattern, as shown in FIG. 3. In addition to the basic discovery event, the chain passes along a device object that is filled in from the database.

As is shown in FIG. 3, the first link in the chain 302 can synchronize the device meta-information such as device name, description, make, model, and GUID. The first link in the chain generates device table updates for the database. It can then pass responsibility to the second link 304, which can manage synchronization of point meta-data, and provide point table updates to the database. The next link in the chain 306 can handle the additional point meta-data associated with alarm points, and updates the events tables of the database. It should be appreciated that additional and other meta-data processing 308 can be included in the chain of responsibility pattern.

In operation, when a change notification is received from the remote POA 206, it is unknown what specific information has changed. Some or all or none of the links may add or change entries in the database. Arranging the links in an ordered chain can also simplify each link, because it can ensure that the previous stage has occurred. For example, in this manner, the alarm component doesn't have to worry about the basic point information for an alarm point, and the point component can assume that the device information is entered. To simplify access, the chaining method can pass both the POA reference from the discovery event and a device object. The device object will contain references to point and alarm links that can get filled in gradually with each successive link. A device object is an entity that contains the description of what constitutes a representation of a device on object oriented coding. The device sync in FIG. 3 is a process that occurs when metadata changes and the device object is the piece of information that gets passed to provide the information.

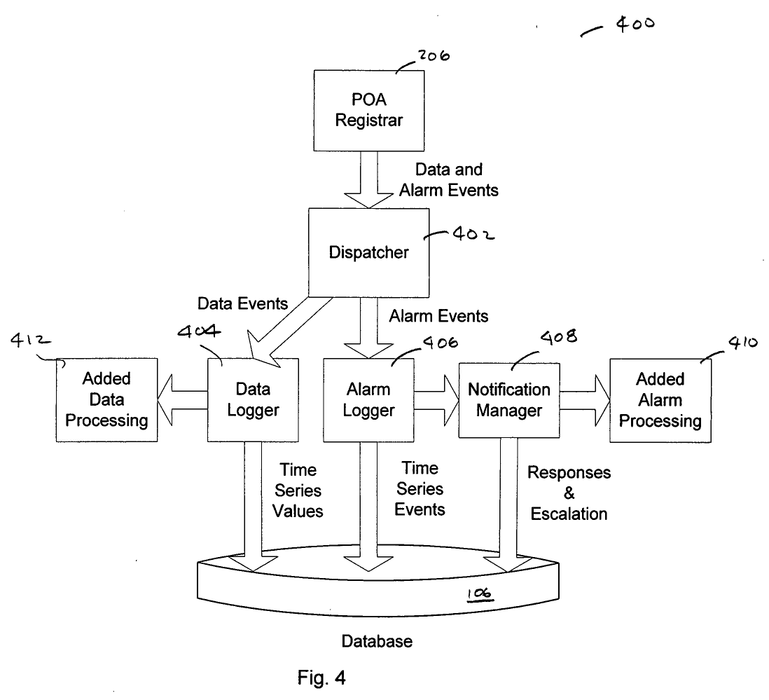

FIG. 4 shows an exemplary block diagram 400 of the data processor event dispatching for the event manager, in accordance with one embodiment of the present invention. In one embodiment, the data event processing has a single point of entry for all data events, including data events, state change events, and alarm events. This single entry, referred to as a dispatcher 402, is responsible for ensuring that the meta-data required to process an event is present in the database 106 before event processing begins. For raw data events, the device and all points should preferably be present. For alarm events, the event information should preferably be present.

In one embodiment, the data and alarm database entries only require the existence of the cross reference, and do not rely on precise synchronization of all meta-data such as display names. It is therefore not necessary for the data processing to wait for full meta-data synchronization to occur, and thus only the insertion of the minimal records is needed.

The dispatcher 402 is responsible for ensuring the appropriate meta-data is present, and for maintaining an ordered wait queue for events received during synchronization. When a device, point, or event is not present in the database, the dispatcher can check with the POA Registrar 206 and POA Proxy 216A, B, . . . to ensure that it is present. The presence of the above, indicates that database synchronization must be occurring and event processing should be delayed. This relieves the individual modules from each having to maintain their own wait queues and minimizes the binding between the two event processing channels. This wait queue can have a reasonable expiration time after which an event is discarded and the error is logged.

The data logger 404 receives data events of any variety, and is responsible for storing the time series values in the database. The alarm logger 406 can then concern itself with alarm events and the time series event table, knowing that the time series value table has already been populated. Similarly, when the notification manager 408 receives an alarm event, it can be assured that the event has already been entered in the database. In addition to the data and alarm loggers and the notification manager, other alarm processing functions 410, as well as added data processing 412 are also envisioned.

FIG. 2B is an exemplary block diagram of the event manager in accordance with one embodiment of the present invention shown exchanging data with remote POAs. As set forth above, the POAs are a part of a device gateway architecture. The POAs can be coupled with a physical device to enable non internet-protocol physical devices to be exposed as a networked device on a server. FIG. 2B shows an overview of the remote access to data from the POAs. FIG. 2B shows that an embodiment for the remote exchange of data between POA client interface 250 and the event manager 102 uses a publish-subscribe pattern. Circled regions A and B in FIGS. 2A-B are operationally equivalent. The service manager launches processes that make up the system. As used herein, Pure Service Platform refers to the hardware and operating system of the gateway, and the Pure Client Platform refers to the publisher side equivalent system of the gateway. This embodiment of the POA client interface 250 includes a publisher 252 on the same platform as the POA. However, it should be noted that the publish-subscribe communication components 252-254 can be replaced with something other than a message bus, such as Jini, web services, and so on. The POA client interface 250 does incorporate some event handling features, including the ability of an event listener to apply a filter to the events it wants to receive.

For event management, the interface 250 includes an event filter, allowing clients to register only for a specified subset of all possible events generated by the POAs, for example for data events and alarm events.

In one aspect, a timestamp is provided for each event to indicate when the event was constructed, as well as a sequence number for the event. The sequence number is a counter that is guaranteed to be sequential for all events from a given POA instance from the time it starts up. Thus, if the event manager is listening to all events, then if it finds that a number has been skipped then it knows that some event data has been missed.

In another aspect, a poll count attribute of the data event can provide a similar sequencing function within the subset of events that are generated as the result of a poll. This can notify a client when the client is missing data, and also can be used to tie together a data event with a state change event and an alarm events generated from the same poll. The number can be guaranteed sequential for events generated by a particular poll request.

Another aspect of the POA client interface 250 is that the publisher 252 acts as a client to the OA Registrar 256, just like other client applications. In one aspect, the remote filtering described herein that stops sending of data events is used for the remote POAs, and the event filtering that is defined on the interface for event registrations with the POA applies to local event listeners after the remote event is sent. For example, a fully active proxy receives all events from the remote system. A client module can register for events from the proxy and supply an event filter so that the client is only notified of events it wants

Another aspect of the event filtering function is directed to an event batching behavior. The event batching behavior is configured to collect events for some fixed or modifiable period of time (e.g., one minute) and send them in a single message via the publisher 252 to the event manager 102 via the subscriber 254. However, when an alarm becomes active, all collected events can be sent without waiting for a period of time.

For the POA subscriber 254, a configuration parameter can specify whether constructed proxies should or should not automatically subscribe to the default data feed from the remote POA. This distinction allows a thin client that only wants to access meta-information and status events to use the same API without taking the performance hit from having proxies processing the full incoming data stream. Proxies configured not to subscribe to the default feed will incur network latency delays if asked for data. When the proxy is asked to poll data, it will then subscribe to the data feed and behave like a default-constructed proxy until all poll requests are canceled.

As will be understood by those skilled in the art, other equivalent or alternative methods for managing a non internet protocol-based physical device according to the embodiments of the present invention can be envisioned without departing from the essential characteristics thereof. Accordingly, the foregoing disclosure is intended to be illustrative, but not limiting, of the scope of the invention which is set forth in the following claims.

What is claimed is:

1. A method of managing a non internet protocol-based physical device, comprising:
coupling a device gateway with a non internet protocol-based physical device, the device gateway configured to expose the physical device as a networked device on a server;
receiving event information from the physical device, wherein the event information includes an event and a device identifier;
responsive to a determination that the event information includes an actionable event, processing the event information, the device identifier, and the actionable event to determine a responsible process; and
notifying the responsible process of the event.

2. The method of claim 1 wherein the event information comprises information related to a discovery event, and wherein a discovery event occurs when a physical device is coupled with the device gateway.

3. The method of claim 1 wherein the event information comprises information related to a discovery event, and wherein a discovery event occurs when a physical device is decoupled from the device gateway.

4. The method of claim 1 wherein the event information comprises information related to a discovery event, and wherein a discovery event occurs when meta-information about the device gateway is changed.

5. The method of claim 4 wherein a change in a meta-information comprises a change selected from the group consisting of: a change in the name, change in the make, change in the model, change in the point information, change in the alarm information, and combinations thereof, for a component of the device gateway.

6. The method of claim 1 wherein the event information comprises data event information.

7. The method of claim 6 wherein data event information comprises information related to an event selected from the group consisting of: a raw data event, a state change event, an alarm event, and combinations thereof.

8. The method of claim 1 wherein the processing the event information comprises updating an event database.

9. The method of claim 1 wherein the processing the event information comprises inserting audit records into an event database.

10. The method of claim 1 wherein the notifying comprises exchanging event data with a mail server.
